(19) United States
(12) Patent Application Publication
(10) Pub. No.: US 2003/0154608 A1
(43) Pub. Date: Aug. 21, 2003

(54) Multi-function drafting instrument

(76) Inventor: Ashfaq Ahmad Khan, Torrance, CA (US)

Correspondence Address: Ashfaq A. Khan, 5519 Coldwater Creek Ct., Baton Rouge, LA, 70808, US

(21) Appl. No.: 10/077,706

(22) Filed: Feb. 15, 2002

(51) Int. Cl. B43L 9/04

(52) U.S. Cl. 33/27.03

(57) ABSTRACT

A drafting instrument is disclosed that functions as a protractor, compass and ruler. The instrument is ideally suited for flat surfaces used for marking including: paper, dry erase board, chalkboard and drafting table. The instrument accommodates pencils, pens, chalks and markers and facilitates the drawings of arcs, circles and parallel lines. The instrument has a built-in protractor for measuring and drawing angles and multiple rulers for measuring distance and drawing straight lines. The preferred embodiment of the instrument is two-piece with an arm shaped main ruler and a single slide-ruler that freely slides in and out of the main-ruler. A place ring with thumbscrew is attached to the slide-ruler to hold a writing tool such as pencil, pen, chalk or marker.

### CROSS-REFERENCE TO RELATED APPLICATIONS

U.S. Pat. Documents

| | | |
|---|---|---|
| 5497558 | Mar. 12, 1996 | Michael J Wagner |
| 4267638 | May. 19, 1981 | Richard A. Heinz; |
| D252615 | Aug. 14, 1979 | Gilbert T. Lopez |
| 5915807 | Jun. 29, 1999 | Artemio M. Ilagan |
| 6049990 | Apr. 18, 2000 | Lewis G. Holland |

### BACKGROUND OF THE INVENTION

This invention relates generally to drafting instruments and more specifically to multi-functional drafting instruments. The invention comprises of a two-piece drafting instrument that may be used on a flat marking surface such as paper, dry erase board, chalk board and drafting table providing protractor, compass, and ruler functions.

The drafting tools currently available that combine the protractor, compass and ruler functions are cumbersome to use, as they almost always require an attachment to a hard flat surface with the help of a suction cup or other means. School students may not easily adapt to the use of such tools, as they do not always have a hard surface to work with. The prior art provided complicated, inflexible, multi-component instruments that are expensive to manufacture and difficult to use. None of the prior art has a placeholder for carrying the writing tool and not all of them are available in small enough size that is suitable for carrying in shirt pocket.

Limited combinations of various drafting tools are shown in the prior art. For example, U.S. Pat. No. 5,497,558 discloses a drafting instrument that functions as a protractor, compass, T-square and ruler. It uses a suction cup to hold on to the writing surfaces, which limits its use to only hard surfaces such as dry erase boards, chalkboards and tables. The instrument also cannot hold the writing tool for carrying purpose as well as drawing parallel lines requires help with additional instrument.

U.S. Pat. No. 3,378,927; discloses a drafting implement which can draw parallel lines on the blackboard and strike arcs about a center located near the edge of a blackboard. However, the device disclosed cannot draw circles, function as a protractor, or mark off distances. Further, the device of U.S. Pat. No. 3,378,927 is manufactured with at least ten different parts.

U.S. Pat. No. 4,267,638 discloses protected pivot adjustable scaled compasses including a slotted body marked with multiple scales. This device also lacks a holding place for a writing tool, and does not have protractor function.

U.S. Pat. No. 5,915,807 discloses an all-in-one drawing apparatus has a protractor integrated with horizontal and vertical rulers, but its use is limited to drawing board only,

U.S. Pat. No. 6,049,990 Discloses a Multifunction Layout Tool capable of performing the functions of an adjustable square, adjustable T-square, try square, combination square, protractor, angle duplicator, depth gauge, rip gauge, rafter-stair layout tool, and compass. The instrument does not have a placeholder for a writing tool and its use of a fastener anchored to the base restricts its mobility.

Thus, there is a need for a simple, yet effective, inexpensive drafting Instrument that combines the functions of a protractor, ruler and Compass in one simple easy-to-use instrument, having a placeholder for a writing tool such as a pen or pencil, can be used on a plain paper without the need for a hard surface to be attached to, and should be made small enough to fit in a shirt pocket.

### BRIEF SUMMARY OF THE INVENTION

This invention provides an arm shaped plate with guiding slots on the inside surface of the arms so that a single plate can be inserted freely into the guiding slot. The plate with two arms is the main-ruler body and the single plate is the slide-ruler body.

One edge of the main-ruler body includes inch or English unit with 1/10-division designations and the opposing edge of the main-ruler body includes inch or English unit with 1/16-division designations, providing ruler functions.

One edge of the slide-ruler includes inch or English unit designations and the opposing edge includes centimeter or metric designations, providing extra ruler functions.

A quarter circle plate is extended on one side of the main-ruler body, including measurement indicia on the periphery, indicating angles for use as a protractor.

A pointed extension extruded from the other side of the main-ruler body providing an axis point during the compass functions. Thus, there is no need for attachment of the instrument to a hard surface as the built-in pointed extension provides a pivot point.

One side of the slide-ruler plate is attached with a ring shaped placeholder with a thumbscrew for holding a writing tool. The ring and the thumbscrew serve two purposes, a) it provides a storage place for a writing tool such as pen, pencil or marker, b) keep the writing tool pressed against the main-ruler body so the slide-ruler does not slip out during compass functions of drawing arcs and circles.

To use the instrument as a compass,

place a writing tool such as pen, pencil or marker inside the ring of the slide-ruler and extend the writing tip until it matches the pointed extension of the main-ruler, place the pointed extension on the center point of the desired arc, slide out the writing tool until the desired radius is reached, secure the writing tool against the main-ruler with the thumbscrew of the place ring, rotate the writing tool while marks are being placed on the surface.

The straight edge perpendicular to the two arms of the main-ruler body provides a reference edge during parallel line drawing functions.

To use the instrument to draw parallel lines,

take out the slide-ruler from the main-ruler body, align the main-ruler edge against the base line, place the slide-ruler against the perpendicular edge of the main-ruler body, slide the main-ruler while being placed against the slide-ruler until the desired distance is reached and draw the other line through the edge of the main-ruler.

Thus, an improved drafting instrument is provided that combines the functions of Compass, protractor and ruler in one easy-to-use and inexpensive instrument that may be used on any flat marking surface such as, paper, and drafting table, chalkboard or dry erase board.

It is an object of the present invention to provide an improved multi-function drafting instrument that is less expensive to manufacture than the multi-function drafting instruments taught in the prior art and can be made in small enough size to fit in user's shirt pocket.

It is also an object of the present invention to provide an improved drafting instrument for use on paper, chalkboards, dry erase boards and drafting tables that has a placeholder for a writing tool and does not need an attachment with the surface for drawing arcs and circles.

Other features and advantages of the invention will appear from the following description in which one embodiment has been set forth in detail in conjunction with the accompanying drawings.

### DETAILED DESCRIPTION OF THE INVENTION

Like reference numerals will be used to refer to like or similar parts from figure to figure in the following description of the drawing.

Considering the cumbersome use of the prior art, the preset invention dramatically improves the use of a single instrument that combines the functions of Compass, protractor and ruler. The instrument may be used on any flat marking surface including; paper, drafting table, chalkboard or dry erase board, but does not need any attachment to the surface. It is especially adaptable to be used in a portable manner so that it can be placed in a user's shirt pocket. Finally, the entire prior art directed to multi-functional drafting instruments is complicated, requires numerous parts and therefore must sell at a substantially higher cost than the devices described by the present invention which may be manufactured from as little as three molded pieces namely, main-ruler, slide-ruler and a thumbscrew.

Turning to FIG. 1, the drafting instrument 10 includes two arm shaped plates 11,12 joined at the body 13 with perpendicular edge 14, forming the main-ruler body of the instrument. A quarter circle plate 15 with periphery 16 is extended from the arm plate body 13. The main periphery 16 carries a plurality of indicia, which indicate degrees or angles when the quarter circle plate 15 is used as a protractor. The other arm 12 has an extrusion 17 with a pointed end 18 to be used as a pivot point during compass functions. The drafting instrument 10 also includes a plate 19 freely movable in the slots 22, 23 (shown in FIG. 4.) forming the slide-ruler portion of the instrument.

The FIG. 2 is the top view of the slide-ruler 19 including place-ring 20 with thumbscrew 21. The place-ring 20 is a placeholder for a writing tool such as pen, pencil or marker. During compass functions the writing tool presses against the main-ruler body providing a grip for the slide-ruler while drawing arcs and circles.

The FIG. 3 is the front view of the slide-ruler 19. The thumbscrew 24 is shown from the front view angle. The indicia 25 of the slide-ruler indicate inches in 1/10-units of measurement. The indicia 26 indicate units in centimeters. The indicia 25 and 26 provide extra ruler functions and also help in drawing parallel lines.

The FIG. 4 is the front view of the instrument 10 without the slide-ruler body. The inside edges of the arm plates 11, 12 carry slot 23 and 22 as a guide for the slide-ruler 19. The peripheral edge of the arm 11 includes indicia 27 which indicate inches in 1/10-units of measurement. The peripheral edge of the arm 12 includes indicia 28 which indicate inches in 1/16-units of measurement. The indicia 27 and 28 provide main ruler functions.

Turning to FIG. 5, the use of the instrument 10 as a compass is illustrated. In the figure the user draws an arc with the help of a writing tool 29. The writing tool is being tightened with the thumbscrew 30, providing a grip against the main-rule arms 11 and 12. The grip prevents the slide-ruler 31 from moving while the arc is being drawn. The pointed extrusion 32 provides the pivot point during the compass functions.

FIG. 6 illustrates the use of the instrument 10 in drawing parallel lines. Place the main-ruler edge 32 aligned with the base line to which a parallel line is to be drawn. Place the slide-ruler 34 against the perpendicular edge 33 of the main ruler. Slide the main-ruler while keeping the slide-ruler 34 held in place until the desired distance is reached and draw the other parallel line.

Thus, the present invention provides one instrument 10 that functions as a compass, protractor, and ruler. The instrument 10 is especially adaptable for holding a writing tool secured in the place ring 20. The instrument 10 does not need to be attached to a flat surface while drawing arcs and circles as the pointed end 18 provides the means for rotating around an axis during compass function. A miniature model can be designed for the purpose of carrying it in a shirt pocket. School students can easily adapt to its use, as it is simple and inexpensive compare to prior art and does not require an attachment to a flat surface.

It should be understood that this invention includes all modifications, which fall within the scope of the appended claims.

### BRIEF DESCRIPTION OF THE SEVERAL VIEWS OF THE DRAWING

This invention is illustrated more or less diagrammatically in the accompanying drawing, wherein:

FIG. 1 is a front plan view of a drafting instrument including the main-ruler, the slide-ruler and the thumbscrew, made in accordance with the present invention;

FIG. 2 is a top view of the slide-ruler part of the drafting instrument giving a perspective of the place ring with the thumbscrew shown in FIG. 1;

FIG. 3 is a front view of the slide-ruler part of the drafting instrument shown in FIG. 1;

FIG. 4 is a front view of the main-ruler of the drafting instrument with a perspective of the slot for the slide-ruler shown in FIG. 1;

FIG. 5 illustrating the use of the instrument in drawing arcs;

FIG. 6 illustrating the use of the instrument in drawing parallel lines;

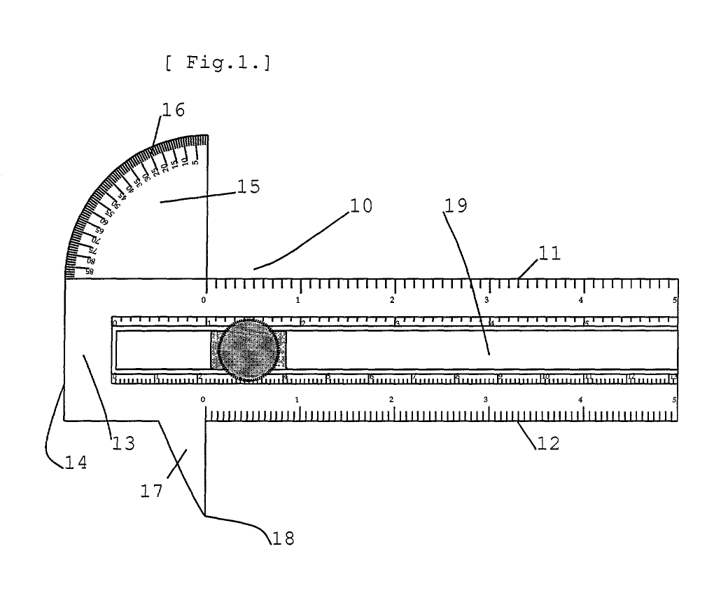

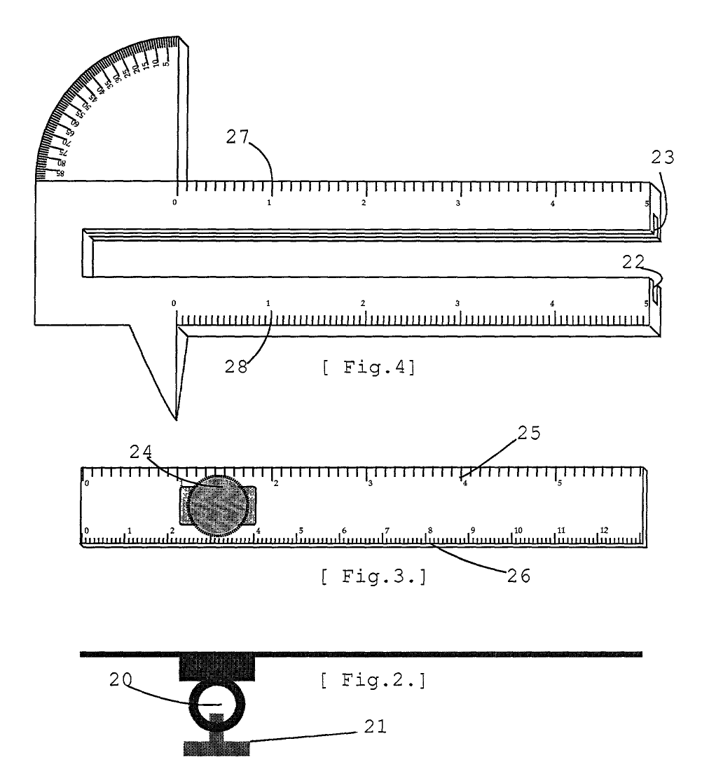

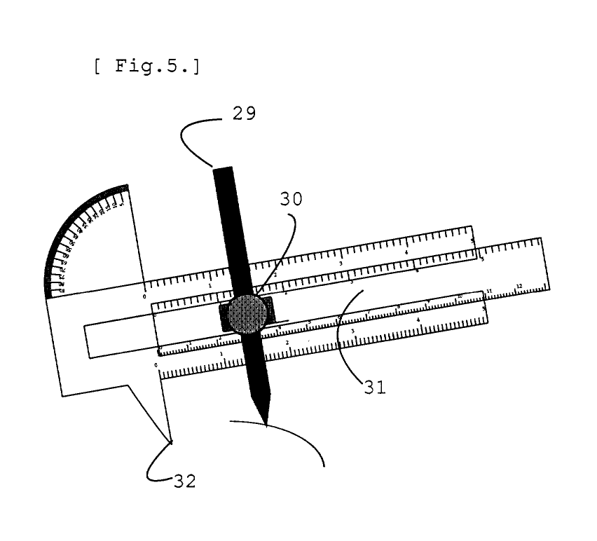

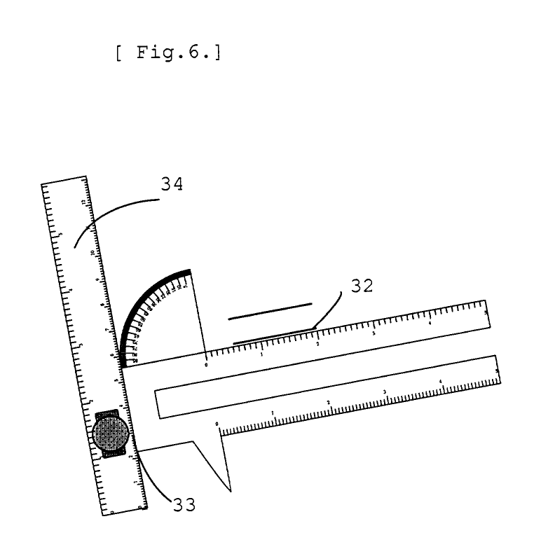

I claim:

1. A drafting instrument providing compass, protractor and ruler functions, the instrument comprising:
an arm shaped plate with the two arms joined on one side and extending outward on the other side (the arms from hereon termed as main-ruler body) including measurement indicia on the peripheral edges indicating distances in inches disposed thereon providing ruler functions,
the arms of the main-ruler body having a slot on the inside surface, that a slide-ruler can be placed inside the slot, so that the slide-ruler is freely movable inside the main-ruler body,
the slide-ruler body also including a plurality of measurement indicia indicating distances in centimeters on one edge and distances in inches on the other edge, the slide-ruler and the plurality of measurement indicia disposed thereon providing extra ruler functions,
a quarter circle plate extending from one arm of the main ruler body including measurement indicia on the periphery indicating angles from 0 to 90 degree providing protractor functions,
a pointed extrusion extending from the other arm of the main-ruler body permitting rotation of the slide-ruler about an axis during the compass functions,
a place-ring with an aperture for thumbscrew attached on one side of the slide-ruler body providing a means for holding a writing tool such as a pencil, pen, chalk or a marker,
a thumbscrew through the slide-ruler place-ring,
a straight edge on the side where the two arms of the main-ruler are joined.

2. The instrument of claim 1,
wherein the peripheral edges of the main-ruler arms, each accommodating said plurality of measurement indicia indicating distances for ruler functions.

3. The instrument of claim 1,
wherein the both edges of the slide-ruler plate, each accommodating said plurality of measurement indicia indicating distances in inches as well as centimeters providing extra ruler functions.

4. The instrument of claim 1,
a quarter circle plate extending from one arm of the main ruler body including measurement indicia on the periphery indicating angles from 0 to 90 degree, when aligned through the edge of the main-ruler arm, providing means of measuring angles between 90 and 180 degrees,

5. The instrument of claim 1,
wherein, a pointed extrusion extending from one arm of main-ruler body permitting rotation of the slide-ruler about an axis, a place-ring attached on one side of the slide-ruler body holding a writing tool such as a pencil, pen, chalk or a marker, a thumbscrew through the slide-ruler place-ring, holding the writing tool, the writing tool while tightened by the thumbscrew pressing against the main-ruler body, securing the slide-ruler against the main-ruler body providing the Compass functions,

6. The instrument of claim 1,
wherein placing the slide-ruler body against the straight edge on the side where the two arms of the main-ruler body are joined, providing facility for drawing parallel lines,

7. The instrument of claim 1,
wherein the arms of the main ruler body with the measurement indicia disposed thereon providing a ruler function.

8. The instrument of claim 1,
wherein the slide-rule plate with the measurement indicia disposed thereon providing a ruler function.

9. The instrument of claim 1,
wherein the arms of the main-ruler body are slotted for slide-rule plate.
